(19) United States
(12) Patent Application Publication
(10) Pub. No.: US 2026/0366481 A1
(43) Pub. Date: Nov. 19, 2026

(54) METHOD FOR HEAT ENERGY RECOVERY IN A PUMPED HYDRO ENERGY STORAGE

(71) Applicant: RENEWABLES 8760 OY, Pirkkala (FI)

(72) Inventor: Timo SOIKKELI, Pirkkala (FI)

(21) Appl. No.: 19/144,206

(22) PCT Filed: Dec. 15, 2023
(86) PCT No.: PCT/FI2023/050700

§ 371 Date: Jun. 27, 2025

(30) Foreign Application Priority Data
Dec. 30, 2022 (FI) 20226188

(51) Int. Cl. F03B 13/06; E02B 9/00

(52) U.S. Cl. CPC F03B 13/06; E02B 9/00; F05B 2220/604; F05B 2220/708; F05B 2260/20; F05B 2260/422

(57) ABSTRACT

The pumped hydro energy storage includes an upper water storage, which may be covered by a roof or cover to prevent cooling of the water, and a lower water storage. The method recovers the thermal energy of the water by using a heat recovery system. The increase in thermal energy of the water is caused by repeating successive water cycles, each of which involves discharging water from the upper water storage to the lower water storage to produce electrical energy and pumping water from the lower water storage to the upper water storage. The thermal energy is produced in the water by recovering the thermal energy generated by the internal losses of the power generation and pumping system when the pumped hydro energy storage is operated.

### CROSS-REFERENCE TO RELATED APPLICATIONS

This application is a § 371 National Stage Application of PCT International Application No. PCT/FI2023/050700 filed Dec. 15, 2023, which claims priority to Finnish Patent Application No. FI 20226188 filed Dec. 30, 2022, both of which are incorporated herein in their entirety.

### THE SUBJECT OF THE SOLUTION

The solution presented is a method for recovering thermal energy in a pumped-storage power plant.

### BACKGROUND TO THE SOLUTION

One well-known energy storage system is the pumped hydro energy storage (PHES or PHS), which is designed for the temporary storage of electrical energy in the form of potential energy of water acting as a medium. The pumped medium is usually fresh water.

The pumped hydro energy storage generates electricity in such a way that it takes more electricity to pump water into the water storage than it produces when the water is extracted from the water storage. The efficiency is around 70-80%. The pumped hydro energy storage contributes to regulating the energy in the grid, as the amounts of electricity produced and consumed in the grid must be the same, and renewable energy sources also need to be supported by regulating power. The pumped hydro energy storage is used as a regulating power on a weekly and daily basis in situations where wind and solar power in particular are at a low level, and the production is boosted by the electricity generated by the energy storage system.

A pumped hydro energy storage can be economically viable based on price differences, as the market price of electricity follows the principles of supply and demand. When there is an abundant supply of electrical energy relative to demand, the price of electricity falls, and conversely, when there is not enough electricity available during periods of high demand, the price of electricity rises.

A pumped hydro energy storage can be started up quickly and usually provides enough electricity to last from a few hours to a few days, depending on the volume of the water storages. The pumped hydro energy storage uses electrical energy to pump water by means of a pump into a storage basin, also called an upper water storage. The pumped hydro energy storage generates electrical energy from the potential energy of the water using a turbine and an electrical generator by discharging the water down from the upper water storage, e.g. into another storage basin, also called the lower water storage. The difference in height between the upper and lower water storage should be as large as possible. The water is pumped from the lower water storage to the upper water storage. The water usually circulates in a closed circuit formed in pumped hydro energy storage.

Pumped hydro energy storages have been located in mountainous areas, for example. In such cases, the upper and lower reservoirs are open to outdoors. Water is transferred from the upper to the lower water storage and back through pipes or tunnels.

Some of the pumped hydro energy storages are also planned to be located underground. Underground facilities such as flow channels, shafts or tunnels have to be excavated for the pumped hydro energy storage. One option is to use discontinued mines. Mines can be more than 1,000 metres deep, in which case the large difference in height between the upper water storage and the lower water storage of the mine provides a large potential energy source. Another option is to build a pumped hydro energy storage underground without exploiting an existing or discontinued mine.

When excavating underground spaces for a pumped hydro energy storage, the placement and use of the excavated rock must be taken into account so as not to pose a problem, e.g. in terms of environmental impact.

When using pumped hydro energy storages, solutions should also be sought that would offer better efficiency and technical feasibilities that would provide a better economic return on investment or synergies.

### SHORT SUMMARY OF THE SOLUTION

The proposed solution for recovering thermal energy is based, among other things, on the observation that the water circulating in the pumped hydro energy storage gets warmer. The internal losses in the pumped hydro energy storage systems, particularly in the turbine and pump, cause power losses but also generate thermal energy in the water, particularly during pumping and turbine operation. In a closed cycle, thermal energy is generated continuously during the operation of the pumped hydro energy storage and thus the recovery of thermal energy can also be continuous or almost continuous.

In a pumped hydro energy storage, water circulates continuously through an upper water storage and a lower water storage, so in one example, the temperature of the circulating water can be raised to the desired final temperature through successive cycles. In one example, a single cycle lasts for 24 hours, so the water temperature can be raised by up to several tens of degrees over a period of several tens of days. During each cycle, for example, the water is warmed by less than one degree, so that water that started at a temperature of about 10 degrees can be heated to a final temperature of about 60-90 degrees over a period of a few months.

In the proposed method, the pumped hydro energy storage is adapted to repeat several successive water cycles, each of which involves discharging water from the upper water storage to the lower water storage, for the purpose of generating electrical energy, and pumping water from the lower water storage to the upper water storage. By repeating the cycles, the thermal energy of the water is increased. The method makes use of a heat recovery system to recover the thermal energy of the water, the increase of which is caused by the repetition of successive water cycles. The upper water storage is either entirely, largely or at least partially covered by a cover structure designed to prevent cooling of the water.

The closed cycle described above allows the conservation of thermal energy as the water circulates from the upper water storage to the lower water storage and back to the upper water storage. To prevent heat loss, the upper reservoir water storage located on the surface is covered and the underground water storage is housed in caverns within the bedrock.

In one example, the heat recovery system is adapted to transfer thermal energy to the district heating network and/or to structures or buildings connected to the upper water storage for different uses.

In one example, thermal energy is recovered from water in the upper water storage or in the flow channel system of a pumped hydro energy storage, for example in the section through which water enters the upper water storage or which is adapted to conduct pumped water from the lower water storage to the upper water storage. In one example, the heat recovery system is located on surface or close to surface.

In one example, a pumped hydro energy storage includes an air flow channel system that is adapted in a controlled manner both to conduct air from the upper water storage to the lower water storage and to conduct air from the lower water storage to the upper water storage. This also creates a closed cycle for the air, allowing the air to retain its thermal energy as it circulates from the upper water storage to the lower water storage and then back to the upper water storage. This eliminates the need to introduce, for example, cool outdoor air into the water storage from which the water is leaving and which therefore needs replacement air, as the volume of air increases.

In this case, the proposed method involves the transfer of air from the upper water storage to the lower water storage, which is displaced when the upper water storage is full because water is pumped into it from the lower water storage. The method involves the transfer of air from the lower water storage to the upper water storage, which is displaced when the lower water storage is full due to the discharge of water from the upper water storage.

Thermal energy recovery can be started after the desired final temperature or higher has been reached. It is most appropriate to maintain the pumped hydro energy storage cycles continuously even during this thermal energy recovery. A pumped hydro energy storage heats the circulating water to the desired final temperature, which can be used, for example, for district heating. For example, desired temperature is 60-90 degrees Celsius when the thermal energy is used in a district heating system with a liquid medium.

This district heating system can be used to heat communities and buildings and other premises on surface in the immediate area or further away. This heat recovery system and the thermal energy it provides can be used in structures or buildings connected to the upper water storage and their premises, e.g. for heating, or for heating nearby buildings and premises on surface or underground.

In one example, the final temperature of the circulating water is allowed to rise higher in a given first period than in a given second period.

For example, the first period is during the warmer periods of the environment, e.g. summer months, when heating demand is lower, and the second period is during the cooler periods of the environment, e.g. winter months, when heating demand is higher and more thermal energy is used. In one example, the first period is between 90 and 95 °C and the second period between 60 and 65 °C.

In addition or alternatively, an integrated structure may be a solution. The integrated structure of the presented solution is used in a pumped hydro energy storage comprising an upper water storage located on surface; a lower water storage located underground and deeper than the upper water storage; and a flow channel system that is adapted to conduct discharged water in a controlled manner from the upper water storage to the lower water storage to generate electrical energy and to conduct pumped water from the lower water storage to the upper water storage.

In an integrated structure, the upper water storage is a storage basin with an upper surface formed by the free upper surface of the water; and the water storage is surrounded, at least in part, by a wall formed by excavated rock and designed to dam water to keep it in the water storage; and the water storage is either wholly or at least partly covered by a cover structure designed to prevent cooling of the water. Structures or buildings with facilities for different uses are located adjacent to the water storage.

The integrated design also includes a heat recovery system adapted to recover the thermal energy of the water.

In one example, structures or buildings are located on and/or above a wall and/or upper water storage. According to one example, the top of the wall has a horizontal surface, and/or the outside of the mound has a sloping surface on one side thereof, and/or the inside of the mound has a sloping surface on the opposite, other side thereof, and structures or buildings are located on top of one or more of said surfaces. Structures or buildings may be located around the wall.

In one example, a waterproof reinforced concrete structure inside the wall forms a storage basin.

The integrated structure according to one example further comprises a photovoltaic system adapted to convert solar radiation into electrical energy by means of a photoelectric phenomenon and comprising a plurality of solar panels. The solar panels are located at least partially above the storage basin and/or the wall.

In addition or as an alternative, the use of excavated rock may be a solution. The proposed solution of using excavated rock is based, inter alia, on the observation that the excavating of underground spaces, such as the underground lower water storage, flow channel system, caverns, or tunnels, produces excavated rock that is used in the construction associated with the surface upper water storage of the pumped hydro energy storage and in the construction of the associated structures. This will reduce or eliminate the need for excavated rock from elsewhere. On the other hand, the need for off-site disposal of rock from underground excavation will be eliminated or substantially reduced compared to the need to locate and dispose of all such excavated rock elsewhere.

In the proposed use, the lower water storage of the pumped hydro energy storage, the flow channel system and/or the tunnels or caverns of the pumped hydro energy storage will be built by excavation, creating excavated rock. That use involves the formation of an upper water storage as a storage basin surrounded, at least in part, by a wall formed from the excavated rock for the purpose of impounding water to keep it in the storage basin.

The wall may form a structure extending above the general ground level. In one example, the top of the wall has a horizontal area on top of which the building is placed and/or the outer surface of the wall forms a sloping area on top of which the building is placed.

In one example, the upper surface in the water storage is the free upper surface of the water. According to one example, the water storage is entirely, substantially, or at least partially covered by a cover structure for preventing cooling of the water.

In one example, a waterproof reinforced concrete structure inside the wall forms a storage basin.

In one example, structures or buildings are placed above or on top of a wall and/or a storage basin, with spaces for different uses. The use of excavated rock also creates the integrated structure described above, which provides the basis for a solution for different applications.

The above-described method for thermal energy recovery and its heat recovery system may also be applied to the above-described pumped hydro energy storage that do not have the above-described integrated structure and all its features, structures, or buildings, but where the above-described increase in thermal energy of water can be observed to occur. In such cases, their upper water storage or storage basin acting as such is either entirely, largely, or at least partially covered by a cover structure designed to prevent cooling of the water. The lower water storage or basin acting as such is built underground into the bedrock.

### BRIEF DESCRIPTION OF THE DRAWINGS

The following is a brief description of the drawings, which are provided to illustrate, and not limit, the various examples and embodiments of the solution presented here.

FIG. 1 shows an example of a pumped hydro energy storage viewed diagonally from above.

FIG. 2 shows an example of the pumped hydro energy storage as shown in FIG. 1, viewed diagonally from above, applied to a pumped hydro energy storage.

FIG. 3 shows a cross-sectional and lateral view of the pumped hydro energy storage example in FIG. 1, applied to an underground pumped hydro energy storage.

FIG. 4 shows a diagram of an example of a heat recovery system for a pumped hydro energy storage.

FIG. 5 shows a diagram of an example of a pumped hydro energy storage electricity generation system and pumping system.

FIG. 6 shows a vertical cross-sectional of the pumped hydro energy storage example in FIG. 1, applied to an underground pumped hydro energy storage.

### DETAILED EXPLANATION OF THE SOLUTION

The features of the presented solution can be better understood by referring to the attached pictures. These figures are schematic representations only and are not intended to indicate relative size and dimensions or to define or limit the number of different embodiments of the solution. The designations used in the description in the following legend are intended to refer only to the examples and embodiments selected from the figures and are not intended to define or limit the number of embodiments of the various examples of the solution. In the figures and in this explanation, the same reference number refers to parts of the solution having similar functionality.

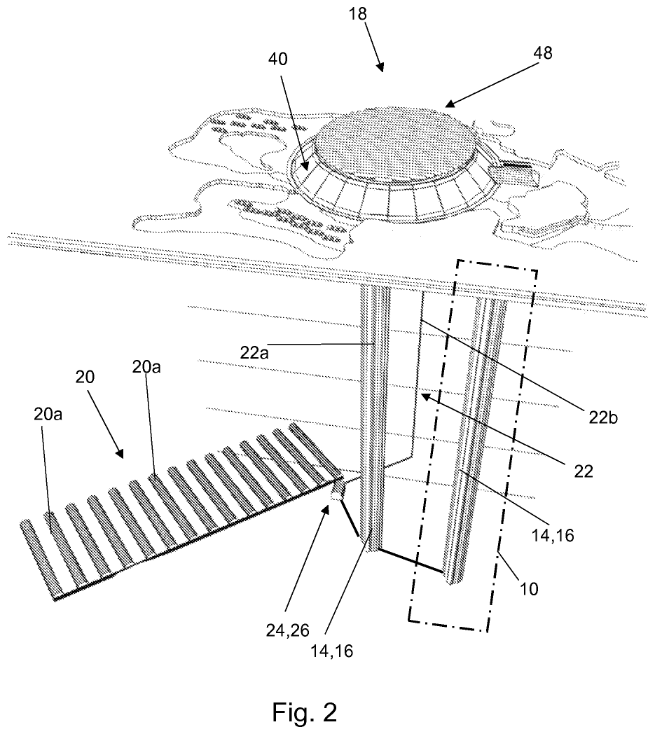

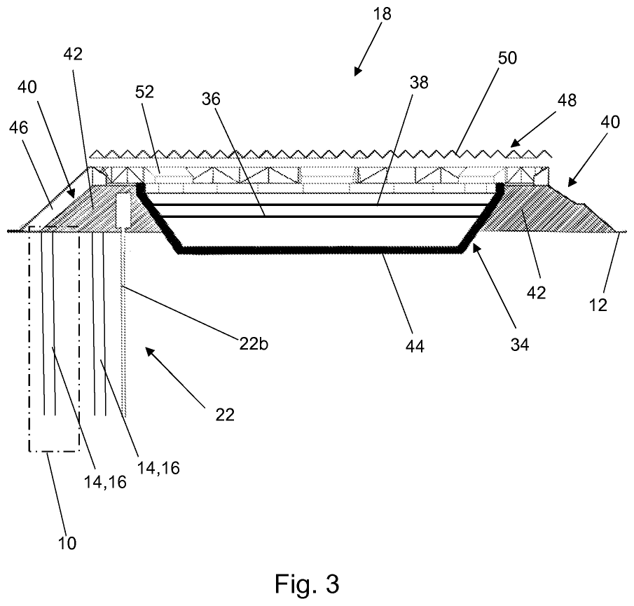

FIGS. 2 and 3 show one example of a mine 10 with a pumped hydro energy storage.

In one example, a mine 10 exploitation of ore is still ongoing or it is being carried out in the past. Ore refers specifically to a mineral deposit that is economically viable to exploit as a result of mining.

Mine 10 in this solution refers to an underground mine. The mine 10 may have an open pit at ground level 12. The mine 10 may comprise underground excavated tunnels 14 or caves and excavated vertical mine shafts 16. The excavated material may be removed to the surface through the tunnels 14 or vertical mine shafts 16 by means of hoisting machines. The vertical mine shafts 16 may include equipment for ore hoisting or, in some cases, waste rock to the surface, as well as shafts for transporting persons and goods.

Mine 10, for example, extends to a depth of 500 to 2,000 metres.

The pumped hydro energy storage comprises an upper water storage 18, a lower water storage 20, and one or more flow channel systems 22 for transferring water. The upper water storage 18, which stores water pumped from the lower water storage 20, is located on surface at ground level 12. The water in the upper water storage 18 has a higher potential energy relative to the water in the lower water storage 20. The lower water storage 20, which stores the water conveyed from the upper water storage 18, is located underground and lower than the upper water storage 18. The lower water storage 20 may be located in the tunnels 14 or caverns of the mine 10.

The flow channel system 22 is adapted for the controlled discharge of water from the upper water storage 18 to the lower water storage 20, for example when the purpose is to generate electrical energy. The flow channel system 22 is further adapted for the controlled transfer of pumped water from the lower water storage 20 to the upper water storage 18.

In one typical example, the flow channel system 22 is adapted for both of these options, so that the flow channel system 22 is used alternately. In one example, the flow channel system 22 comprises a first and a second channel system. According to one possible example, the first channel system is only for discharging water and the second channel system is only for pumping water.

The flow channel system 22 may comprise substantially horizontal or inclined channels 22a and/or vertical channels 22b, for example vertical shafts. A channel is most often referred to herein as a transfer channel such as a tunnel, cavern, or shaft, typically excavated underground during the construction of a pumped hydro energy storage. At the same time, a lower water storage or other facilities are built or excavated for the pumped hydro energy storage.

Another option is to build a pumped hydro energy without an existing or discontinued mine 10. In this case, the connections to the mine 10 through the mine shafts 16 or tunnels 14 cannot be used deep underground, but the necessary connections have to be built or excavated, as well as the lower water storage 20 and the flow channel system 22. These connections also provide access to underground facilities where, for example, the pumped hydro energy storage′ power supply system 24 and pumping system 26 are located.

The electricity generation system 24 shown in FIGS. 2 and 5 is positioned underground and adapted to generate electrical energy by utilizing water flowing in the flow channel system 22 and discharged from the upper water storage 18. In one example, the electricity generation system 24 utilizes the kinetic energy of the discharged water, for example by means of a water turbine 24a. According to one example, the electricity generation system 24 includes a water turbine 24a and an electric generator 24b that are driven by the flowing water. The potential energy generates the kinetic energy. The pumping system 26 shown in FIGS. 2 and 5 is positioned underground and adapted to pump water from the lower water storage 20 to the upper water storage 18 using the flow channel system 22. In one example, the pumping system 26 comprises a pump 26a and a motor 26b, for example an electric motor, which drives the pump 26a. The pump 26a generates a pressure that allows water to be lifted from the lower water storage 20 to the upper water storage 18.

In one example, the electricity generation system 24 and the pumping system 26 are at least partially integrated with each other. For example, the electrical generator 24b is adapted to also act as a motor 26b driving the pump 26a.

When the purpose is to recover thermal energy in a pumped hydro energy storage, the aim is to raise the temperature of the water circulating in the pumped hydro energy storage to or above the desired final temperature so that the thermal energy of the water can be utilised and, for example, thermal energy recovery can be started. To facilitate this, the upper water storage is either entirely, largely, or at least partially covered by a cover structure 38 designed to prevent cooling of the water.

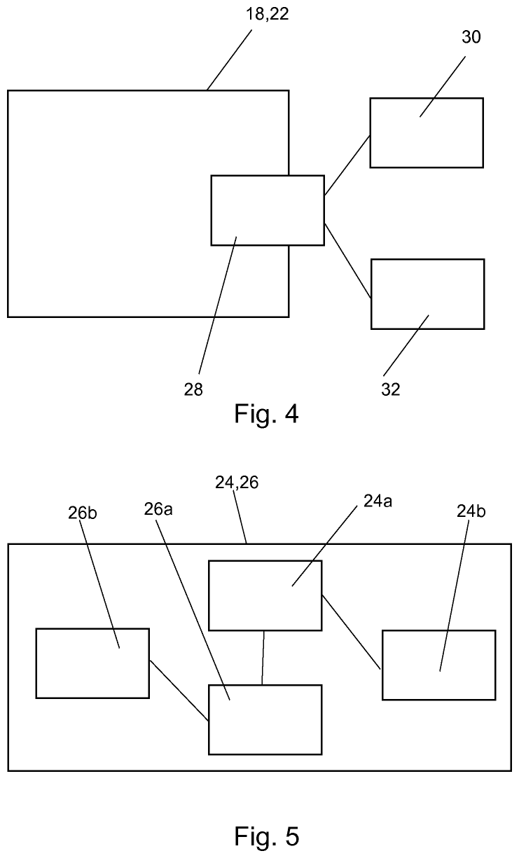

As shown in FIG. 4, for the above-mentioned recovery of the thermal energy of the water, a heat recovery system 28 adapted to recover the thermal energy of the water circulating in the pumped hydro energy storage is arranged in connection with the pumped-stored power plant, e.g. in the upper water storage 18 or in the flow channel 22. For this purpose, the heat recovery system 28 may comprise one or more heat exchangers. The increase in thermal energy is caused by repeating the water circulation cycle described above. The thermal energy is recovered from water contained in, for example, the upper water storage 18 and/or the flow channel system 22, for example, the portion of the flow channel system 22 through which the water enters the upper water storage 18 or is adapted to conduct pumped water from the lower water storage 20 to the upper water storage 18. In one example, the heat recovery system 28 is located on surface or close to surface. For example, a heat recovery system 28 is adapted to transfer thermal energy to a desired medium to raise its temperature. In one example, the heat recovery system 28 transfers thermal energy to the district heating network 30 for use in locations where the district heating network is extended, or to the heating system 32 for use in locations where the heating system 32 network is extended. The locations in question are, for example, structures or buildings connected to the upper water storage 18 for different uses.

In one example, the medium in question is a liquid that circulates in the district heating network 30 and is used to heat buildings connected to the district heating network 30. According to another example, the medium is a liquid or air that circulates in the heating system 32 and is used to heat structures or buildings or spaces therein or a mine or underground spaces therein. According to one example, said structure, building, or any of its premises is a greenhouse for growing plants by means of heat and artificial light.

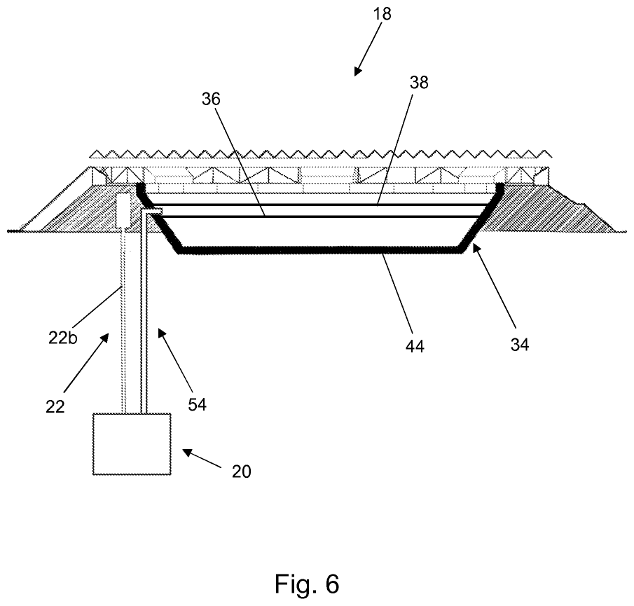

As shown in the example of FIG. 6, the pumped hydro energy storage further comprises an air flow channel system 54 that is adapted to controllably direct air from the upper water storage 18 to the lower water storage 20. The air flow channel system 54 is further adapted to controllably direct air from the lower water storage 20 to the upper water storage 18.

In a typical example, the air flow channel system 54 is adapted for both of these options, with the air flow channel system 54 being used alternately. According to one example, the air flow channel system 54 comprises a first channel system and a second channel system. According to one possible example, the air flow channel system 54 or only its first channel system is meant for conducting replacement air to the lower water storage 20, where the volume of air increases as the water is pumped. Air is introduced from the upper water storage 18, where the volume of air is then reduced. The air flow channel system 54, or only one of the channel systems, is for conducting replacement air to the upper water storage 18, where the volume of air is increased when the water is discharged. Air is introduced from the lower water storage 20, where the volume of air is then reduced. The water entering the upper and lower water storages 18, 20 increases the volume of water and displaces air from the total volume allocated to that water storage, which is discharged into the air flow channel system 54.

The air flow channel system 54 may include various fan and valve devices to control the air flow. The one or more inlets and outlets of the air flow channel system 54 are preferably located above the water surface in the water storage.

Air flow channel system 54 may comprise substantially vertical, horizontal or inclined channels, most commonly referred to here as a transmission channel such as a tunnel, caverns or shaft, typically excavated underground, for example during the construction of a pumped hydro energy storage.

When the intention is to form an integrated structure with several functions, it will be located in the same area as the pumped hydro energy storage described above. The pumping station comprises an upper water storage 18, a lower water storage 20, and a flow channel system 22 for transferring water, for the purpose of generating electrical energy and pumping water.

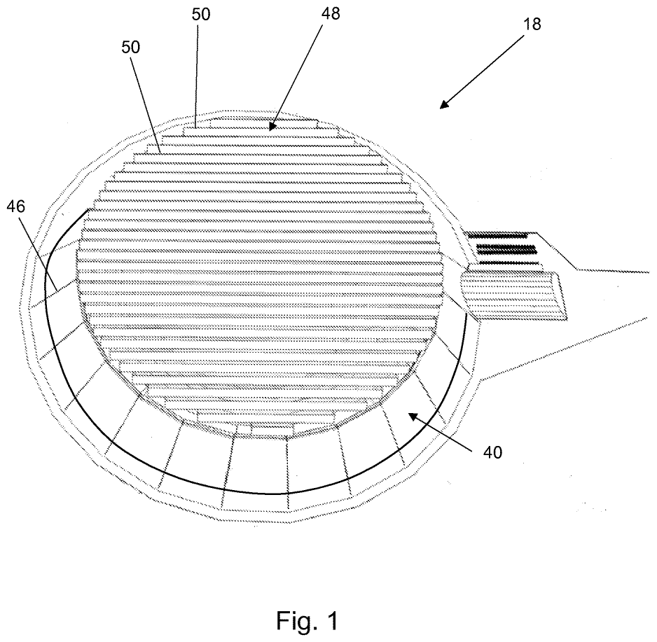

Referring to FIGS. 1, 2 and 3, the upper water storage 18 forms a storage basin 34 with an upper surface 36 forming the free upper surface of the water. The height of the upper surface varies during the operation of the pumped hydro energy storage. The upper surface 36 is at its highest point when the storage basin 34 is pumped to the desired maximum volume. Similarly, the upper level 36 is at its lowest in a situation where electrical energy has been produced for a long period of time and the lower water storage 20 has been filled to its designed maximum volume. In one example, the storage basin 34 is substantially at the surface level 12.

The upper water storage 34 is entirely, largely, or at least partially covered by a cover structure 38 designed to prevent cooling of the water. According to some examples, the cover structure 38 may comprise support structures connected to or disposed around or on structures or buildings surrounding the upper water storage 34. The water storage 34 is surrounded, at least in part, by the wall 40, the purpose of which is to dam water to keep it in the water storage 34. Adjacent to the wall 40 are structures or buildings containing spaces 46, 52 for various uses.

In one example, the structures or buildings are positioned above and/or on top of the wall 40 and/or the water storage 34. The structures or buildings may be disposed around the wall 40. The structures or buildings may include spaces 46, 52 for various uses, such as rooms, recreational spaces, meeting and training rooms, research and laboratory spaces, plant growing spaces and/or technical spaces, such as a greenhouse.

In one example, the outer side of wall 40 comprises a substantial vertical or inclined surface. According to an example, the opposite, inner side of the wall 40 comprises a substantially vertical or inclined surface. For example, the slope of the aforementioned inclined surface, i.e., the angle with respect to the horizontal plane or ground plane, is about 30-45 degrees. According to one alternative, the top of wall 40 has a horizontal surface formed thereon. The wall 40 may form a structure extending above the general level of the ground surface 12. For example, the height of the wall 40 is between 20 and 40 metres extending above the level of the ground 12. The height of the wall 40 is determined, for example, by the intended volume and surface area of the storage basin 34.

In some examples, one or more of the surfaces described above are covered by the structures or buildings described above.

In one example, the storage basin 34 is formed using waterproof reinforced concrete structures, for example as its base and/or sides. According to one example, the inner side of the wall 40 has a substantially vertical or inclined surface with a reinforced concrete structure extending thereon to form the base 44 of the storage basin 34.

According to one example, the wall 40 is at least partially formed from the rock material 42. This rock material 42 is, for example, extracted from underground, e.g. from bedrock, either from the construction of pumped hydro energy storage used in this description or from elsewhere. The utilization of the rock material 42 described above means that the wall 40 is at least partially formed from the excavated rock material 42, which is extracted from the mine 10 or from underground, for example from bedrock, in connection with the construction of the various facilities of the pumped hydro energy storage. It is the pumped hydro energy storage of this report which is exploited and in connection with which the wall 40 is located. According to one example, the rock material 42 in question is obtained when excavating a lower water storage 20, and/or a flow channel system 22, for example a vertical channel 22b, and/or tunnels 14 or caverns, and/or other underground spaces for the pumped hydro energy storage.

According to an embodiment of FIG. 2, the lower water storage 20 comprises a plurality of excavated caverns 20a, for example substantially horizontal, which may be connected with each other and/or via a flow channel system 22 with an electricity supply system 24 and/or a pumping system 26.

The wall 40 surrounds storage basin 34 around all or part of its perimeter. For example, the wall 40 follows the shape of a square, rectangle, ring or oval, or is undulating in shape.

According to one example, the integrated structure further comprises a photovoltaic system 48 adapted to convert solar radiation into electrical energy through a photoelectric phenomenon. The photovoltaic system 48 includes an array of solar panels 50. The solar panels 50 are disposed, for example, entirely, substantially, or at least partially, above the storage basin 34 and/or the wall 40.

For example, the electrical energy generated by the photovoltaic system 48 may be fed into the regional electrical grid and/or utilized at locations where the electrical grid of the photovoltaic system 48 is extended, such as pumped hydro energy storage, structures, buildings, mines 10 or their premises, or underground facilities as described above. One or more covered spaces 52 may be formed between the solar panels 50 and the storage basin 34 or wall 40 for the various uses described above. Above the storage basin 34 and/or the wall 40, there may be a roof or support structure on which the solar panels 50 are placed.

The integrated structure described above can be defined using the following example 1 and further examples.

Example 1: Integrated structure in a pumped hydro energy storage including:
an upper water storage (18), which is located on surface;
a lower water storage (20), which is located underground and deeper than the upper water storage (18);
a flow channel system (22) that is adapted to conduct discharged water from the upper water storage (18) to the lower water storage (20) in a controlled manner to generate electrical energy and to conduct pumped water from the lower water storage (20) to the upper water storage; and
a heat recovery system (28) adapted to recover the thermal energy of water; and with an integrated structure
the upper water storage (18) is a storage basin (34), the upper surface of which is the free upper surface of the water;
the storage basin (34) is at least partially surrounded by a wall (40) formed by quarried rock (42) and designed to dam water to keep it in the storage basin (34);
the storage basin (34) is either wholly or at least partially covered by a cover structure (38) designed to prevent cooling of the water; and
structures or buildings with spaces (46, 52) for different uses are located adjacent to the wall (40).

Example 2. The integrated structure of Example 1, wherein the excavated aggregate (42) is generated during construction by excavation of a lower water storage (20), a flow channel system (22), and/or pumped hydro energy storage tunnels (14) or caves.

Example 3. The integrated structure according to example 1 or 2, wherein the structures or buildings are positioned above and/or on top of the wall (40) and/or storage basin (34).

Example 4. The integrated structure of any one of examples 1-3, wherein the wall (40) has a horizontal surface formed on a face thereof, one side of the wall (40) has a substantially vertical or inclined surface, and an opposite, second side of the wall (40) has a substantially vertical or inclined surface.

Example 5: The integrated structure of any one of examples 1 to 3, wherein the wall (40) has a horizontal surface on top of which structures or buildings are located, and/or the wall (40) has a substantially vertical or sloping surface on one side of the wall outside of the wall (40) on which structures or buildings are located, and/or the wall (40) has a substantially vertical or sloping surface on the opposite, second side of the wall inside of the wall (40) on which structures or buildings are located.

Example 6. The integrated structure of any one of examples 1-5, wherein the interior of the wall (40) comprises a waterproof reinforced concrete structure forming a storage basin (34).

Example 7. The integrated structure of any one of examples 1-6, further comprising:
a photovoltaic system (48) adapted to convert solar radiation into electrical energy by means of a photoelectric phenomenon, comprising an array of solar panels (50) placed at least partially above a storage basin (34) and/or a wall (40).

Example 8. The integrated structure of any one of examples 1-7, where pumped hydro energy storage further comprises:
an electricity generation system (24) located underground and adapted to produce electrical energy by utilizing water flowing in a flow channel system (22) and discharged from an upper water storage (18); and
a pumping system (26) located underground and adapted to pump water from the lower water storage (20) to the upper water storage (18) using a flow channel system (22).

The use of aggregate extracted from a pumped hydro energy storage as described above can be defined by the following example 9 and further examples.

Example 9. Use of aggregate extracted from a pumped hydro energy storage and contained in the pum ped-storage power plant:
an upper water storage (18), which is located above ground;
a lower water storage (20) located underground and deeper than the upper water storage (18); and
a flow channel system (22) that is adapted for the controlled transfer of discharged water from the upper water storage (18) to the lower water storage (20) and for the transfer of pumped water from the lower water storage (20) to the upper water storage (18); and
in which the lower water storage (20), flow channel system (22), and/or pumped hydro energy storage tunnels (14) or caverns are constructed by extraction, thereby creating excavated rock (42); and
the use of which comprises the formation of an upper water storage as a storage basin (34), surrounded at least in part by a wall (40) formed from the excavated rock (42) in question and intended to dam water in order to retain it in the storage basin (34).

Example 10. The use according to example 9, comprising forming a horizontal surface on a wall (40) on one side, forming a substantially vertical or inclined surface on the wall (40) on one side, and forming a substantially vertical or inclined surface on an opposite, second side of the wall (40).

Example 11. The use according to example 9 or 10, comprising placing structures or buildings on a wall (40) and/or in a storage basin (34), where the structures or buildings have spaces (46, 52) for different uses. The solution and its features described in this explanation are referred to, inter alia. The terms “comprising”, “comprising”, “containing”, “including”, and “being” are intended to be open definitions so as not to exclude the possibility of additional features which are not explicitly mentioned, unless expressly so stated.

The various examples and embodiments of the solution presented in this explanation are illustrative and not intended to be limiting. The presented solution is intended to include all the examples and embodiments defined in the appended claims.

1. A method for recovering thermal energy in a pumped hydro energy storage, comprising:
an upper water storage located above ground and wholly covered by a cover designed to prevent cooling of the water;
a lower water storage, which is located underground and deeper than the upper water storage;
a flow channel system, which is adapted to conduct discharged water from the upper water storage in a controlled manner to the lower water storage to generate electrical energy and to conduct pumped water from the lower water storage to the upper water storage;
an electricity generation system located underground and adapted to produce electrical energy by utilizing water flowing in the flow channel system and discharged from an upper water storage; and
a pumping system located underground and adapted to pump water from the lower water storage to the upper water storage using the flow channel system; and
a heat recovery system adapted to recover the thermal energy of water; and
the pumped storage plant is adapted to repeat several successive water cycles, each of which includes discharging water from the upper water storage to the lower water storage to generate electrical energy and pumping water from the lower water storage to the upper water storage; and
wherein the method comprises:
causing an increase in the thermal energy of the water by repeating successive water cycles and producing thermal energy in the water by recovering the thermal energy produced by the internal losses of the electricity generation and pumping system during operation of the pumped storage power plant; and
recover thermal energy from water using the heat recovery system.

2. The method according to claim 1, further comprising:
start recovering thermal energy using the heat recovery system after reaching or exceeding a predetermined final temperature.

3. The method according to claim 2, wherein the final temperature is between 60 and 90 degrees Celsius.

4. The method according to claim 1, wherein the heat recovery system is adapted to transfer thermal energy to the district heating network and/or to structures or buildings connected to the upper water storage for different uses.

5. The method according to claim 1, further comprising:
recover thermal energy from water in the upper water storage or in the flow channel system.

6. The method according to claim 1, further comprising:
heating the water circulating in the pumped hydro energy storage to a predetermined final temperature, allowing the final temperature to rise during the first predetermined period to a higher level than during the second predetermined period.

7. The method according to claim 6, wherein:
the first period is during warmer periods in the environment, when the heating demand is lower; and
the second period is during cooler periods in the environment, when heating demand is higher, and more thermal energy is used.

8. The method according to claim 6, wherein:
during the first period the temperature is between 90 and 95 °C and/or during the second period between 60 and 65 °C.

9. The method according to claim 1, further comprising:
converting solar radiation into electrical energy by a photoelectric phenomenon, using a photovoltaic system comprising a set of solar panels placed at least partially above the upper water storage.

10. The method according to claim 1, wherein the pumped storage facility comprises:
an air flow channel system, which is adapted to conduct air from the upper water storage to the lower water storage and to conduct air from the lower water storage to the upper water storage in a controlled manner;
wherein the method
diverting from the upper water storage to the lower water storage, which air is displaced when the upper water storage is filled by pumping water from the lower water storage; and
diverting from the lower water storage to the upper water storage, air which is displaced when the lower water storage is filled by water discharged from the upper water storage.

11. The method according to claim 1, wherein:
the upper water storage is a storage basin, the upper surface of which is the free upper surface of water; and
the storage basin is at least partially surrounded by a wall formed by excavated rock and designed to dam water to keep it in the storage basin.

12. The method according to claim 11, wherein the excavated rock is generated during excavation of the lower water storage, the flow channel, and/or pumped hydro energy storage tunnels or caves.

13. The method according to claim 1, further comprising:
constructing the lower water storage, the flow channel system, and/or pumped hydro energy storage tunnels or caverns by excavation, creating excavated rock; and
the upper water storage is formed into a storage basin surrounded, at least in part, by a wall formed from the excavated rock in question and designed to dam the water in order to keep it in the storage basin.

14. The method according to claim 13, wherein structures or buildings with spaces for different uses are located adjacent to the wall.

15. The method according to claim 11, wherein a horizontal surface is formed on the face of the wall, a substantially vertical or inclined surface is formed on one side of the wall, and a substantially vertical or inclined surface is formed on the opposite, other side of the wall.

16. The method according to claim 10, wherein the closed air-flow channel system displaces the air volume of one water storage into the other water storage during each water cycle without introducing outside air.

17. The method according to claim 1, wherein the successive water cycles are continued until the temperature of the circulating water has increased by at least 20 K relative to its initial temperature before thermal energy is recovered, wherein preferably the temperature rise is several tens of degrees.

18. The method according to claim 17, wherein the temperature rise is several tens of degrees.

19. The method according to claim 1, wherein the heat-recovery system comprises at least one heat exchanger arranged in the inlet region of the upper water storage or in the flow-channel system.
